(19) United States
(12) Patent Application Publication
(10) Pub. No.: US 2026/0244338 A1
(43) Pub. Date: Aug. 20, 2026

(54) Non-Volatile Main Memory Subsystem

(71) Applicant: Greenliant IP, LLC, Santa Clara, CA (US)

(72) Inventor: Bing Yeh, Los Altos Hills, CA (US)

(21) Appl. No.: 19/531,490

(22) Filed: Feb. 5, 2026

Related U.S. Application Data
(63) Continuation of application No. PCT/US26/13711, filed on Feb. 3, 2026.
(60) Provisional application No. 63/761,003, filed on Feb. 20, 2025.

(51) Int. Cl. G06F 3/06

(52) U.S. Cl. CPC G06F 3/0604; G06F 3/0656; G06F 3/0673

(57) ABSTRACT

A non-volatile main memory subsystem includes a main memory interface for communicating with a host system; static random-access memory (SRAM); first non-volatile memory (NVM); and second NVM having storage capacity that is at least ten times the storage capacity of the first NVM. The first NVM has write endurance that is at least ten times, and typically at least one hundred times, the write endurance of the second NVM, erase speed that is at least twice as fast as erase speed of the first NVM, and/or programming speed that is at least ten times as fast, and typically at least a hundred times as fast, as programming speed of the second NVM. The main memory subsystem includes a first level cache resident in the SRAM, a second level cache resident in the first NVM, and a controller for read/write control and maintaining one or more address mapping tables.

### RELATED APPLICATIONS

This application is a continuation of PCT Application No. PCT/US26/13711, filed Feb. 3, 2026, which claims priority to U.S. Provisional Patent Application No. 63/761,003, filed Feb. 20, 2025, each of which is hereby incorporated by reference in its entirety.

### TECHNICAL FIELD

This relates generally to memory device architectures, including but not limited to architectures in which electrically programmable and erasable non-volatile memory serve as main memory.

### BACKGROUND

The use of dynamic random access memory (DRAM) in memory architecture is widespread due to its speed, density, and compatibility across various systems and devices. However, using DRAM as main memory can become expensive, both in terms of the cost of the memory components per unit of memory storage, due at least in part to limitations on the extent to which DRAM can be scaled down in size, and high power consumption. As such, providing a memory subsystem that uses types of memory that are lower cost and have lower power consumption is advantageous. These advantages are particularly beneficial in computer systems and devices that implement artificial intelligence, as such systems tend to require large memory capacity.

### SUMMARY

Accordingly, there is a need to provide a memory system that emulates DRAM that includes high capacity, low cost non-volatile memory acting as main memory for the system.

In accordance with some embodiments, the disclosed embodiments provide a non-volatile main memory subsystem (NVMM subsystem). The NVMM subsystem includes: a main memory interface for communicating with a host system; static random-access memory (SRAM); first non-volatile memory, comprising a first type of non-volatile memory (e.g., NOVRAM, sometimes called NVRAM), the first non-volatile memory having first storage capacity, excluding overprovisioning and metadata storage, first write endurance, first erase speed, and first programming speed; and second non-volatile memory (e.g., NAND memory), comprising a second type of non-volatile memory different from the first type of non-volatile memory; the second non-volatile memory having second storage capacity, excluding overprovisioning and metadata storage (e.g., capacity reserved for or otherwise used to store metadata of the NVMM subsystem), of at least ten times the first storage capacity, excluding overprovisioning and metadata storage, of the first non-volatile memory; the first type of non-volatile memory having write endurance that is at least ten times (and, preferably, at least one hundred times) the write endurance of the second type of non-volatile memory, erase speed that is at least twice as fast as erase speed of the second type of non-volatile memory, and/or programming speed that is at least ten times (and, preferably, at least one hundred times) as fast as the programming speed of the second type of non-volatile memory. The NVMM subsystem further includes main memory, resident in the second non-volatile memory, for storing data (e.g., host data); a first level cache resident in the SRAM, from which the host system accesses data stored in the main memory system; a second level cache, resident in the first non-volatile memory, having greater storage capacity than the first level cache; and a controller for read/write control and maintaining mapping tables (also sometimes address mapping tables, translation tables, or address translation tables) that map host-specified memory locations to locations in the first level cache, second level cache and main memory.

In accordance with some embodiments, a NVMM (non-volatile main memory) subsystem comprises a main memory interface for communicating with a host system; static random-access memory (SRAM); first non-volatile memory having a first write endurance; second non-volatile memory having a second write endurance, wherein the first write endurance of the first non-volatile memory is greater than the second write endurance of the second non-volatile memory; and a controller for managing the storage of data received from the host system to the SRAM, first non-volatile memory, and second non-volatile memory of the NVMM subsystem in response to write commands received from the host system. The SRAM includes a first write buffer for buffering (e.g., storing) data to be written to the first non-volatile memory, and the first non-volatile memory includes a second write buffer for buffering (e.g., storing) data to be written to the second non-volatile memory.

### BRIEF DESCRIPTION OF THE DRAWINGS

For a better understanding of the various described embodiments, reference should be made to the Description of Embodiments below, in conjunction with the following drawings in which like reference numerals refer to corresponding parts throughout the figures.

FIGS. 1 and 1A are diagrams illustrating a non-volatile main memory (NVMM) subsystem in accordance with some embodiments.

FIG. 2 is a diagram illustrating writing and reading data in a NVMM subsystem in accordance with some embodiments.

### DESCRIPTION OF EMBODIMENTS

Reference will now be made in detail to embodiments, examples of which are illustrated in the accompanying drawings. In the following detailed description, numerous specific details are set forth in order to provide a thorough understanding of the various described embodiments. However, it will be apparent to one of ordinary skill in the art that the various described embodiments may be practiced without these specific details. In other instances, well-known methods, procedures, components, circuits, and networks have not been described in detail so as not to unnecessarily obscure aspects of the embodiments.

It will also be understood that, although the terms first, second, etc. are, in some instances, used herein to describe various elements, these elements should not be limited by these terms. These terms are only used to distinguish one element from another. For example, a first memory device could be termed a second memory device, and, similarly, a second memory device could be termed a first memory device, without departing from the scope of the various described embodiments. The first memory device and the second memory device are both memory devices, but they are not the same memory device, unless the context clearly indicates otherwise.

The terminology used in the description of the various described embodiments herein is for the purpose of describing particular embodiments only and is not intended to be limiting. As used in the description of the various described embodiments and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” is, optionally, construed to mean “when,” or “upon,” or “in response to determining,” or “in response to detecting,” depending on the context. Similarly, the phrase “if it is determined” or “if [a stated condition or event] is detected” is, optionally, construed to mean “upon determining,” or “in accordance with a determination that,” or “in response to determining” or “upon detecting [the stated condition or event]” or “in response to detecting [the stated condition or event],” depending on the context.

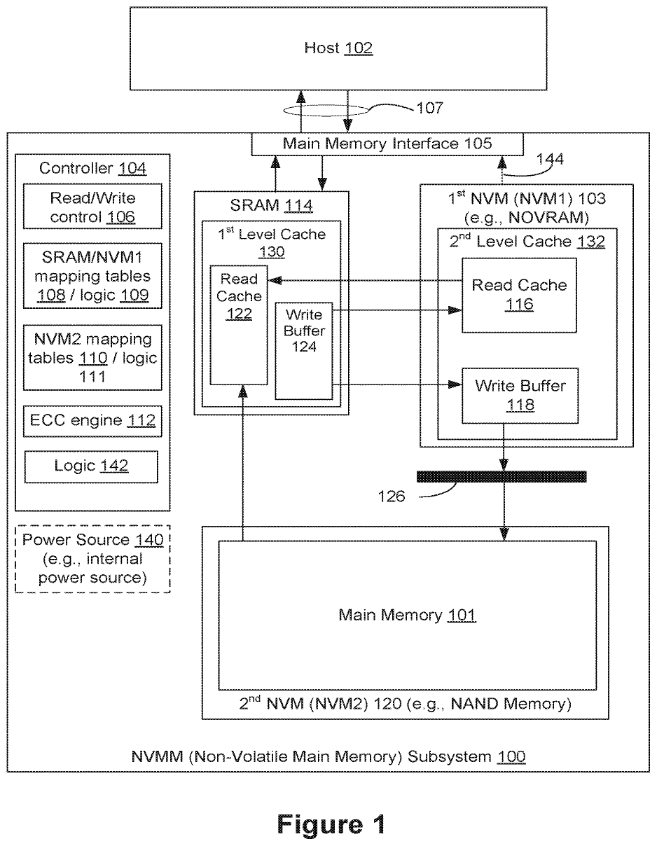

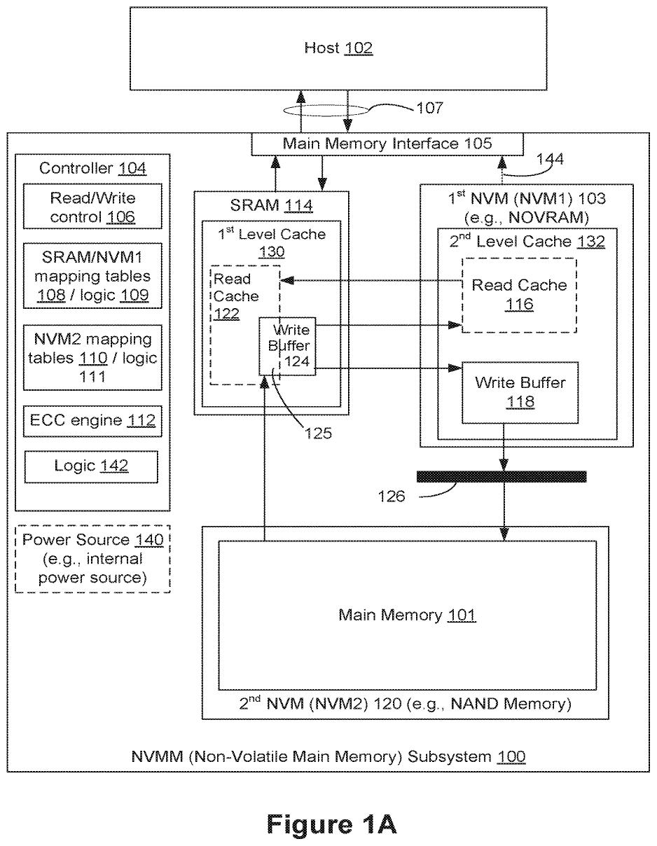

Attention is now directed toward embodiments of a non-volatile main memory (NVMM) subsystem, as illustrated in FIG. 1, which depicts a computer system that includes a host 102 (e.g., a host computer) and a NVMM subsystem 100 that includes two or more levels of cache memory and non-volatile main memory 101. In some embodiments, the NVMM subsystem 100 includes at least two types of non-volatile memory, where data is written (e.g., at different write speeds) to the respective types of non-volatile memory. For example, in some embodiments, the NVMM subsystem 100 includes static random-access memory 114 (SRAM 114), a first non-volatile memory 103 (NVM 103), and a second non-volatile memory 120 (NVM 120). First NVM 103 is implemented using a first type of non-volatile memory, such as non-volatile random-access memory (NOVRAM), and is sometimes herein called or labelled NVM1, and second NVM 120 is implemented using a second type of non-volatile memory, such as NAND memory, and is sometimes herein called or labelled NVM2, as described in more detail below. In some embodiments, the NVMM subsystem 100 includes a controller 104 that dynamically manages the storage of host data in SRAM 114, first NVM 103 and second NVM 120, as described in more detail below.

For example, data, herein called host data, being written by host 102 to the NVMM subsystem 100 is written at a first write speed to the first NVM 103 before being written, with a second, slower, write speed, to the second NVM 120. From the perspective of the host 102, data written by the host 102 to NVMM subsystem 100 is considered to be safely stored, and the host 102 does not know, or need to know, what types of memory are being used to store the data written to the NVMM subsystem 100. Compared with main memory implemented using DRAM to store host data (i.e., data received from the host 102 for storage), the NVMM subsystem 100 stores host data using non-volatile memory as main memory, which has much lower cost per unit (e.g., per byte) of physical storage and uses much less power than DRAM.

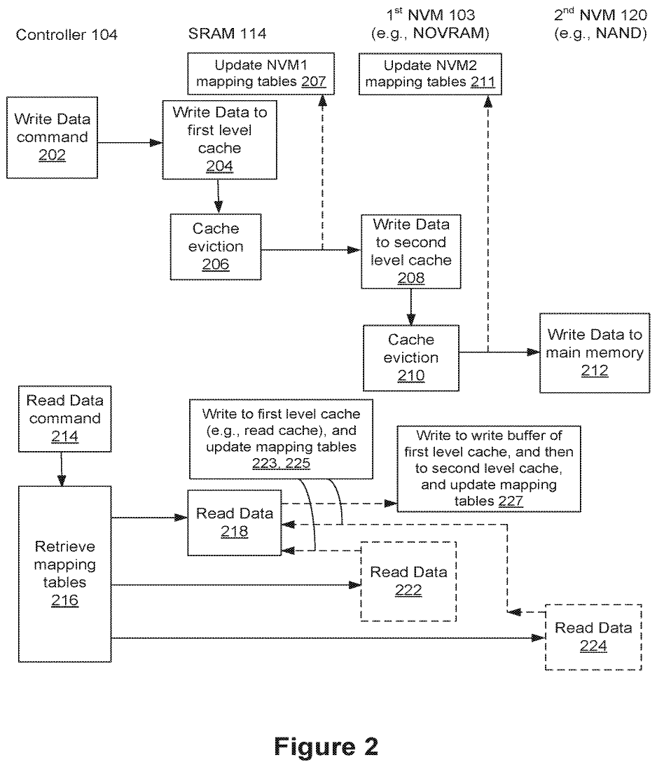

In some embodiments, the host 102 is coupled to NVMM subsystem 100 via a memory bus 107 and a main memory interface 105 of the NVMM subsystem 100. In some embodiments, in response to a request (e.g., a write data command) from the host 102 to write first data to main memory, the controller 104 of NVMM subsystem 100 causes the NVMM subsystem 100 to initially write the first data to SRAM 114, and then, as needed (as discussed in more detail below), to first NVM 103, and to second NVM 120 (e.g., as described with reference to FIG. 2). Data (e.g., host data written by host 102 to NVMM subsystem 100) stored in SRAM 114 (e.g., in first level cache 130) may be changed (e.g., overwritten with new host data, in some cases many times) by host 102 before that data is written to the first NVM 103 (e.g., in second level cache 132). Similarly, data in the first NVM 103 (e.g., in second level cache 132) may also be changed many times before being written to the second NVM 120 (e.g., written to main memory 101). As such, the SRAM 114, the first NVM 103 (the first type of non-volatile memory), and second NVM 120 (e.g., the second type of non-volatile memory) together form the memory components of a NVMM subsystem 100 that acts as main memory of host 102.

Examples of the first NVM 103 and second NVM 120, and characteristics of those memory components needed for enable long term operation of the NVMM subsystems 100 are discussed in more detail below.

In some embodiments, NVMM subsystem 100 includes at least two levels of cache memory (sometimes called two levels of cache), including a first level cache 130 in SRAM 114, and a second level cache 132, in first NVM 103, that has greater storage capacity than the first level cache 130, as described in more detail below. In some embodiments, the two levels of cache in NVMM subsystem 100 function as additional levels of cache memory that supplement cache memory in the host 102. For example, if host 102 includes first (L1) and second (L2) levels of cache memory, the first level cache 130 of the NVMM subsystem 100 functions as an L3 cache for host 102 (e.g., is configured as an L3 cache of the host system 102). Similarly, in some embodiments, the second level cache 132 of the NVMM subsystem 100 functions as an L4 cache for host 102 (e.g., is configured as an L4 cache of the host system 102). Each level of cache memory, in both host 102 and NVMM subsystem 100, is used to store host data of the host 102. In the embodiments described below, only host data is stored in the first level cache 130, second level cache 132 and main memory 101 of the NVMM subsystem 100, and metadata (described in more detail below) is stored elsewhere (e.g., in other portions of SRAM 114 and the first NVM 103, under the control of controller 104.

In some embodiments, the controller 104 maintains mapping tables, sometimes called translation tables or address translation tables, mapping host-specified memory locations to locations in the first level cache 130, second level cache 132 and main memory 101. The locations of host data, or copies of such data, stored in the NVMM subsystem 100 are tracked by mapping tables stored in SRAM 114 (e.g., SRAM/NVM1 mapping tables 108, for memory locations storing host data in SRAM 114 and first NVM 103), and in the first NVM 103 (e.g., NVM2 mapping tables 110, for memory locations storing host data in the second NVM 120). In some embodiments, there are two copies of the NVM1 mapping table 108, one stored in NVM1 103 and another stored in SRAM 114. However, in some embodiments, in addition to the copy saved in NVM1 103, only a subset of the/NVM1 mapping table 108, acting as a read cache of the NVM1 mapping table, is stored in SRAM 114. Furthermore, the controller 104 is configured to write data from the first level cache 130 to the second level cache 132 in accordance with a cache eviction policy for the first level cache, to write data from the second level cache 132 to main memory 101 in accordance with a cache eviction policy for the second level cache 132, and to update the mapping tables to keep track of where data, and copies of data, is stored in the NVMM subsystem 100.

In some embodiments, the controller 104 includes logic 142 that monitors and maintains the health of memory blocks in NVM1 and NVM2, for example by retiring memory blocks that fail to meet predefined data retention requirements (e.g., as detected using methods that employ error checking and correction) and updating the mapping tables 108, 110 accordingly, and for example by using wear leveling to spread P/E cycles as evenly as possible or practical across the memory blocks in NVM1 103 and across the memory blocks in NVM2. In some embodiments, logic 142 also monitors for power failures and interruptions and controls or triggers (e.g., in conjunction with logic 109) the copying of updated metadata of the mapping tables 108 in SRAM 114 to NVM1 103 to protect the integrity of the mapping tables 108.

In some embodiments, the mapping tables are stored in SRAM 114, but the mapping tables, or information from the mapping tables, are also saved to the first NVM 103. Saving the mapping tables, or copies of the mapping tables, to the first NVM 103 secures those tables from power failures. For example, in some embodiments, the NVM2 mapping tables 110 are saved to the first NVM 103, but portions of the NVM2 mapping tables (for memory locations in the second NVM 120) that are in active use are maintained in SRAM 114 to enable those mapping tables to be efficiently accessed and updated, and updates to the NVM2 mapping tables 110 are saved to the NVM2 mapping tables located in (e.g., stored in) the first NVM 103 to ensure that integrity of the NVM2 mapping tables is maintained even in the event of a power failure or power down. Although not specifically drawn in FIG. 1, the caching or buffering of mapping table metadata and other metadata in SRAM 114, NVM1 103 and NVM2 follows a similar flow pattern as that shown for host data.

Coherence of the data stored in the first level cache 130, the second level cache 132, and the main memory 101 is maintained by the timely update (by controller 104) of the mapping tables stored in SRAM 114 and first NVM 103. For example, data that is being written to main memory 101 in the second NVM 120 is temporarily stored in a write buffer 118 in the first NVM 103 until the data has been written to the main memory 101 in the second NVM 120, and the mapping tables are updated as the data is moved during that process. In some embodiments, after data has been written to the main memory 101, such data may still remain in the first NVM 103, but in the read cache 122 instead of the write buffer 118. For example, the portion of the write buffer 118 that stores the data written to the main memory is reallocated to the read cache 112. More generally, when data is transferred between SRAM, first NVM 103 and second NVMM 102 (e.g., from NVM 120 to NVM 103 during a read operation), the corresponding mapping tables 108, 110 are updated, e.g., simultaneously or at substantially the same time, in order to maintain accurate records of where valid data and copies of valid data are stored in the NVMM subsystem 100.

For example, respective data that is written into the first NVM 103 is temporarily stored in the first NVM 103 until the respective data has been written to the second NVM 120, and after the respective data has been written to the second NVM 120, the portion of NVM 103 that was used to store that respective data is marked invalid and later erased and overwritten by other data. Data is written at a slower rate to the second NVM 120 than the rate at which data is written to the first NVM 103 (e.g., NOVRAM as NVM 103 has a faster write speed than the second NVM 120 (e.g., NAND memory)).

Second NVM 120 includes main memory 101, and is sometimes said to function as main memory for the host 102. In some embodiments, in addition to main memory 101, which is used to store host data and associated metadata for error checking and correction information, second NVM 120 also stores mapping table metadata, e.g. retired bad memory block addresses, and memory block ages, i.e. cycle count, of active memory blocks. However, in some embodiments, mapping table metadata of the NVMM subsystem 100 is primarily stored in SRAM 114 and the first NVM 103.

In some embodiments, the NVMM subsystem 100 illustrated in FIG. 1 is particularly advantageous in systems, or use cases, where frequent access to large quantities of data is needed and there is a limited amount of data that is updated after it has been written to the main memory 101 in NVM 120. For example, in artificial intelligence (AI) applications, a model that is stored in main memory 101 (in second NVM 120) may be updated (e.g., to personalize the model) over time, but typically, the amount of updating to the model is very small relative to the size of the model itself.

In some embodiments, the NVMM subsystem 100 illustrated in FIG. 1 simulates (e.g., from the perspective of the host 102) DRAM, or DRAM-implemented main memory, without using DRAM to store host data. For example, when host 102 writes data to NVMM subsystem 100, or reads data from NVMM subsystem 100, it uses DRAM access protocols and a DRAM-compatible memory interface, but has no knowledge as to what types of memory are actually used in NVMM subsystem 100. As long as the data access rates (i.e., read and write rates) of the NVMM subsystem 100 are compatible with the applicable memory access protocols and memory storage requirements of the host 102, including the storage capacity specified by or for the NVMM subsystem 100, the host 102 treats the NVMM subsystem as though it is DRAM. For this reason, the NVMM system 100 is said to simulate DRAM-implemented main memory.

In some embodiments, the memory bus 107 that is coupled between the host 102 and the NVMM subsystem 100 is a DRAM-compatible memory bus and main memory interface 105 of the NVMM subsystem 100 is, from the perspective of host 102, a DRAM-compatible memory interface. Thus, from the perspective of host 102, NVMM subsystem 100 is functionally the same as, or equivalent to, a memory subsystem implemented using DRAM. However, in the embodiments described herein, the NVMM subsystem 100 does not include DRAM that stores the host data (e.g., the aforementioned first data) written by host 102 to NVMM subsystem 100 (e.g., using data write commands).

In some embodiments, SRAM 114 includes, in addition to the first level cache 130, a write buffer 126 used to facilitate writing host data from the first NVM 103 to main memory 101 in the second NVM 120, e.g., to augment the SRAM buffer (not shown in FIG. 1) that is typically embedded in NAND chips of second NVM 120. Further, the first level cache 130 includes a read cache 122 and a write buffer 124. The read cache 122, write buffer 124, and write buffer 126, sometimes called SRAM buffers, in addition to being used to store or cache host data, are also used for facilitating the transfer of data between host 102, the first NVM 103, and between the first NVM 103 and the second NVM 120.

In some embodiments, the second level cache 132 includes a read cache 116 and write buffer 118. In some embodiments, the read cache 116 and write buffer 118 of the second level cache 132 are dynamically assigned portions of the first NVM 103, dynamically assigned by controller 104 in accordance with read and write commands received from the host 102 and the status of data written to main memory 101. For example, in some embodiments, logical addresses (or at least a portion of the logical addresses) in the second level cache 132, in first NVM 103, are partitioned into the read cache 116 and write buffer 118 of the second level cache 132. Similarly, the read cache 122 and write buffer 124 of the first level cache 130 are dynamically assigned portions of the SRAM 114, dynamically assigned by controller 104 in accordance with read and write commands received from the host 102 and the status of data written to the first NVM 103 and main memory 101. For example, in some embodiments, logical addresses (or at least a portion of the logical addresses) in the first level cache 130, in SRAM 114, are partitioned into the read cache 122 and write buffer 124.

As discussed in more detail below, in addition to storing host data, SRAM 114 also stores mapping tables 108 and other metadata (e.g., settings, configuration data, status information, etc.) of the NVMM subsystem 100. The aforementioned metadata is sometimes called (or includes) administrative data. Furthermore, to ensure that integrity of the data stored in NVMM subsystem 100 is maintained even in the event of a power failure or power down of the NVMM subsystem 100, the first NVM 103 is also used to durably store the aforementioned metadata, or at least a sufficient portion of the metadata to enable recovery of all metadata essential for correct operation of the NVMM subsystem 100 when power is restored to the NVMM subsystem 100. As a result, the second level cache 132 occupies less than 100% of the first NVM 103.

### Characteristics of Non-Volatile Memory in NVMM Subsystem

Although FIG. 1 illustrates the first non-volatile memory 103 as NOVRAM, it will be understood that other types of non-volatile memory (e.g., MRAM, RRAM, FRAM, high speed NOR flash memory, or other types of non-volatile memory) may be used instead of, or in addition to, NOVRAM. In some embodiments, the system illustrated in FIG. 1 includes at least two different types of non-volatile memory, each type of non-volatile memory including different properties (e.g., storage capacity, write endurance, erase speed, programming speed, and/or other properties).

In some embodiments, the second NVM 120 (e.g., implemented using a second type of non-volatile memory, such as NAND memory) has a storage capacity, excluding overprovisioning (discussed in more detail below) and metadata storage, of at least ten times (or, at least 20 times, 50 times, or more typically, at least a hundred times) the storage capacity of the first NVM 103 (e.g., implemented using a first type of non-volatile memory, such as NOVRAM), excluding overprovisioning and metadata storage. Although FIG. 1 illustrates the second non-volatile memory 120 as NAND memory, it will be understood that other types of non-volatile memory may be used instead of, or in addition to, NAND memory.

In some embodiments, the first NVM 103 is implemented using non-volatile memory having uniformly sized memory sectors (e.g., erase sectors) (e.g., 4K bytes in size), and the second NVM 120, which includes main memory 101, is implemented using non-volatile memory having uniformly sized memory sectors that are substantially larger than the memory sectors of the first NVM 103 (e.g., 256 times, 4096 times, or even larger multiples of the size of the memory sectors of the first NVM 103).

In terms of physical addresses in the first NVM 103, the read cache 116 and write buffer 118 may be commingled in the physical address space of the first NVM 103. Similarly, in terms of physical addresses in SRAM 114, the read cache 122, write buffer 124, and write buffer 126 may be commingled in the physical address space of SRAM 114. The reason for such commingling in the physical address spaces, is that, in some embodiments, portions of the NVM 103 and SRAM 114 are dynamically allocated to the read caches 116, 122 and write buffers 118, 124 as host data is written to, read from and transferred among, the first level cache 130, second level cache 132, and main memory 101. The controller 104 dynamically manages the storage of host data among the first level cache 130, second level cache 132, and main memory 101, using read/write control logic 106, mapping tables logic 109, mapping tables logic 111, and error checking and correction (ECC) engine 112, some of which are implemented as hardware controlled functions to meet speed of operation requirements of the NVMM subsystem 100, and some of which may be implemented in firmware within the controller 104.

In some embodiments, the SRAM/NVM1 mapping tables 108 are stored in SRAM 114, the NVM2 mapping tables 110 and the controller firmware are stored in the first NVM 103, and the controller includes logic (e.g., logic 109 and logic 111 in FIG. 1) for maintaining those tables. In the example shown in FIG. 1, logic 109 maintains the SRAM/NVM1 mapping tables 108, and logic 111 maintains the NVM2 mapping tables 110. The SRAM/NVM1 mapping tables are sometimes collectively called the first level mapping table, and the NVM2 mapping tables are sometimes collectively called the second level mapping table.

In some embodiments, in the second level cache 132, the read cache 116 stores temporary copies of subsets of the data stored in main memory 101, and the write buffer 116 stores data received from the host 102 via the first level cache 130, for which a corresponding copy has not yet been written (or is in the process of being written) to main memory 101. Once data in the write buffer 118 is written to the main memory 101, the portion of the write buffer 118 storing that data is changed into a portion of the read cache 116, and remains a portion of the read cache until the data is marked invalid in accordance with a cache eviction policy implemented by the controller 104 (e.g. by logic 109). The memory blocks with invalid data will be erased subsequently in a background process so that the read cache 116 has room to store other data. Overprovisioning in both NVM1 103 and NMV2 120 enables such data management to be efficiently implemented.

### NVM Characteristics

In some embodiments, the first type of non-volatile memory (e.g., NOVRAM, used in the first NVM 103) has a write endurance that is at least ten times (e.g., or, more typically, at least a hundred times, or a thousand times) the write endurance of the second type of non-volatile memory (e.g., NAND, used in the second NVM 120), and/or programming speed that is at least ten times as fast (e.g., or, more typically, at least a hundred times as fast) as the programming speed of the second type of non-volatile memory. In some embodiments, the first type of non-volatile memory has a write endurance that is at least 100, 1000, or 10,000 times the write endurance of the second type of non-volatile memory. It is noted that the NVM 120 typically has 20 to 1000 times the capacity (excluding overprovisioning and metadata storage) of the first NVM 103, and therefore, in order to rewrite the entire second NVM 120 (or the portion of NVM 120 that is used as main memory 101), the first NVM 103 would typically have to be overwritten at least 20 to 1000 times (e.g., because new or updated data is written first to the write buffer 118 in the first NVM 103 and is then written to the second NVM 120 (e.g., copied or transferred from the first NVM 103 to the second NVM 120 in accordance with a cache eviction policy for the first level cache 130). More generally, the first type of non-volatile memory must have sufficient write endurance to enable updating the data in main memory 101 (in the second type of non-volatile memory, in NVM 120) many times over. In some embodiments, the first NVM 103 comprises a first type of non-volatile memory having write endurance (average write endurance) of at least one million, 10⁷, 10⁸, or 10⁹ program/erase cycles (P/E cycles).

Overprovisioning is sometimes defined as “excess memory,” or “spare memory,” beyond a logical space or a capacity of a drive or memory device or memory subsystem. Overprovisioning allows a memory device to continue to provide a specified amount of storage even when some units of memory in the memory device are being erased, as well as when some units of memory in the memory device fail to function properly (e.g., and, as a consequence, are retired by marking them as bad memory blocks) and are logically replaced with units of memory from the overprovisioning. The specified amount of storage (e.g., 256 GB) in main memory 101 also does not include the portions of main memory used to store metadata and redundant information, such as error checking and correction information (e.g., error checking and correction information generated and used by error checking and correction (ECC) engine 112 to ensure that data read from main memory 101, or more generally the NVMM subsystem 100, is correct). The percentage or portion of memory dedicated to (or allocated to) overprovisioning may be different for memory devices implemented using different technologies, and thus different portions or percentages of the first NVM 103 and second NVM 120 may be dedicated to or allocated to overprovisioning. It is for these reasons that the storage capacity of the first NVM 103 and second NVM 120 are sometimes discussed in terms of storage capacity, excluding overprovisioning.

Other than providing spare memory units to compensate for retired memory units, overprovisioning also facilitates erasing of invalid memory blocks (memory blocks with invalid data) in the background while the NVMM subsystem 100 continues to provide sufficient memory capacity for ongoing read or write operations. Memory blocks in NVM1 and NVM2 with invalid data are erased using a background operation or process, while memory blocks from the overprovisioning pool are used in their place to store data being written to or read from NVM1 103 or NVM2 120, which improves performance of the NVMM subsystem 100, e.g., by avoiding the need to pause memory write operations while memory blocks are erased so as to make them available to store data.

As discussed above, in some embodiments, the main memory 101 for storing data is resident in the second NVM 120. In some embodiments, the second NVM is also used to durably store configuration and/or administrative data for the NVMM subsystem 100, and in such embodiments main memory 101 occupies less than 100% of the second NVM 120, excluding overprovisioning.

In some embodiments, memory access (e.g., both writing data and reading data) by the host 102 to and from the NVMM subsystem 100 is routed through the first level cache 130 in SRAM. However, in some embodiments, the host 102 also can read data directly from the second level cache 132 in the first NVM 103, as depicted in FIG. 1 by data path 144, which may be implemented by a data bus that transfers data (e.g., directly) from the first NVM 103 to the main memory interface 105.

First Level Cache with Overlapping Read Cache and Write Buffer

As shown in FIG. 1A, in some embodiments, in the first level cache 130, a logical address may belong to the read cache 122 and the write buffer 124 simultaneously, i.e. in an overlapping portion of the read cache 122 and the write buffer 124, when data is written from the host to the first level cache 130 and has not yet been written to the second level cache 132. Stated another way, in some embodiments, read/write control logic 106 (discussed in more detail below) of controller 104 initially writes data (host data) received from host 102 to a portion of the first level cache 130 in SRAM 114 that belongs to (e.g., has SRAM addresses assigned to) both the read cache 122 and write buffer 124, and that portion of the first level cache 130 is, for convenience, herein called an on overlapping portion 125 of the read cache 122 and write buffer 124. Until that host data is written to the second level cache 132, the host data remains in the overlapping portion 125 of the read cache 122 and write buffer 124, and host data stored at SRAM locations in the overlapping portion 125 of the read cache 122 and write buffer 124 is available, under the control of read/write control logic 106, for both reading and overwriting by host 102 without having to update the SRAM mapping tables 108. Since the read cache 122 and write buffer are in SRAM 114, data stored in the overlapping portion 125 of the read cache 122 and write buffer 124 (e.g., data recently written by the host to the NVMM subsystem 100) can be overwritten many times without the need to update the SRAM mapping table 108, thereby making the NVMM subsystem 100 faster (on average) at handling host data reads and writes, and more efficient than implementations in which all data overwrites in the first level cache 130 require SRAM mapping table updates because host data reads and writes that access the overlap region 125 of the first level cache are not interrupted by SRAM mapping table updates. Once data stored to the overlapping portion 125 of the first level cache 114 is written to the second level cache, the SRAM mapping table 108 is updated to specify that portion of the first level cache 114 storing that data is mapped solely to the read cache 122.

### Data Write and Read Operations

When host 102 writes data to the NVMM 100, that data is initially written in SRAM 114, for example in the write buffer 124 of the first level cache 130 in SRAM 114, or in the read cache/write buffer overlap portion 125 of the first level cache 130, as discussed in more detail above with reference to FIG. 1A. Further operations within NVMM 100 for durably storing the newly written data within NVMM 100 are discussed in more detail below. Similarly, when host 102 reads data from NVMM 100, that data is typically retrieved from the read cache 122 of the first level cache 130 in SRAM 114. An exception is discussed below. However, in order for the data requested by the host 102 to be present in the read cache 122, multiple internal operations within NVMM 100 may need to be performed, as discussed in more detail below.

In some embodiments, the controller 104 is configured to write data (e.g., data not already stored in main memory 101) from the write buffer 124 of the first level cache 130 to the second level cache 132, for example when space is needed in the first level cache 130 to store data being written by host 102 to the NVMM subsystem 100, or to store data being read from main memory 101 to the host 102. Which data in the write buffer 124 of the first level cache 130 is written to the second level cache 132 is determined by the controller 104 in accordance with a cache eviction policy for the first level cache 130. The cache eviction policy for the first level cache 130 is also used by controller 104 to determine when to overwrite data in the first level cache 130 with other data to be stored in the first level cache 130.

In some embodiments, the write buffer 124 of the first level cache 130 is relatively small, typically between a few kilobytes (e.g., 4 KB) and a few tens of megabytes (e.g., 10 MB) and is dynamically assigned in the first level cache 130. The size of the write buffer 124 optionally depends on the total capacity (excluding overprovisioning and metadata storage) of main memory 101, in order to facilitate fast and complete copying of the entire write buffer 124 to the write buffer 118 of the second level cache 132 as well as the backup of updated metadata of the mapping tables 108 in SRAM 114 to NVM1 103 under the control of logic 109 and 142, in the event of a power failure or interruption. Thus, when host data, received from host 102, is written to the write buffer 124, it is often subsequently written by controller 104 to the second level cache 132 (e.g., to the write buffer 118 of the second level cache 132) shortly thereafter, and such data in SRAM 114 can be either overwritten by other data or remain stored in the read cache 122 if subsequent access by the host 102 immediately afterward is needed. Since the second level cache 132 is in non-volatile memory (the first NVM 103), data saved to the second level cache 132 is durably written and protected from power failures and interruptions. With regard to the backup of updated metadata of the mapping tables 108 in SRAM 114 to NVM1 103 under the control of logic 109 and 142, it is noted that if main memory 101 has a capacity of 2 TB (terabytes), excluding over provisioning and metadata storage, the NMV1 mapping tables 108 may be as large as 10 MB and it is more cost efficient to store those mapping tables in NVM1 than SRAM. Furthermore, in some such implementations, only a subset (e.g., less than 20%) of the NVM1 mapping tables 108 is also stored in SRAM 114, and only the changed metadata in such subset in SRAM 114 needs to be copied to NVM1 103 in the event of a power failure or interruption.

Similarly, the controller 104 is configured to write data (e.g., data not already stored in main memory 101) from the write buffer 118 of the second level cache 132 to the main memory 101, for example when space is needed in the second level cache 132 to store data being evicted from the first level cache 130 to the second level cache 132, or to store data being read from the second NVM 120 (e.g., from main memory 101) to the host 102. Which data in the write buffer 118 of the second level cache 130 is written to the second NVM 120 (e.g., to main memory 101) is determined by controller 104 in accordance with a cache eviction policy for the second level cache 132. The cache eviction policy for the second level cache 132 is also used by controller 104 to determine when to remove data from the read cache 116 of the second level cache 132, to make room for other data to be stored in the second level cache 132.

In some embodiments, when the host 102 updates or overwrites data read from main memory 101, and a prior version of that data is still stored in the read cache 116 of the second level cache 132 (e.g., stored in a set of second level cache locations mapped to the addresses used by the host 102 to access the data being updated), the updated data is initially written to the first level cache 130 by the controller 104, and the mapping tables 108, 110 are updated (e.g., by logic 109, 111) to indicate that the data (e.g., for a set or range of memory addresses used by the host 102) is now stored in the first level cache 130 instead of read cache 116 (in the first NVM 103) and main memory 101 (in the second NVM 120). The overwritten data in the read cache 116, which is no longer valid, is removed from the read cache 116 by marking the memory address storing the overwritten data as invalid (i.e., marked to indicate that it stores invalid data), and subsequently erased in a background process by the controller 104, so that those portions of the first NVM 103 can be used to store other data. Similarly, the memory location with overwritten data in main memory 101 is marked as invalid (e.g., by logic 111) and enqueued for erasure. The controller 104 is configured to perform a garbage collection process when a sufficient amount of data in a memory block in the second NVM 120 is marked as invalid. Garbage collection is typically a background process, identifying blocks of non-volatile memory (e.g. NMV 120) in which more than a threshold amount of the data (e.g., more than 50%) is marked as invalid, or identifying blocks of non-volatile memory having the largest amounts of data marked as invalid, copying any valid data from the identified blocks to new blocks, and then erasing the identified blocks so that those blocks are available to store new data.

Data stored in the first level cache 130, in either the read cache 122 or write buffer 124, may be overwritten or updated by the host 102 multiple times before it is saved to the second level cache 132 or main memory 101. Similarly, data stored in the second level cache 132, in either the read cache 116 or write buffer 118, may be overwritten or updated by the host 102 multiple times before it is saved to main memory 101.

In an example, first data that was written to the first level cache 130 is subsequently written to the second level cache 132 in first NVM 103 if that data is being evicted from the first level cache 130 in accordance with a cache eviction policy for the first level cache 130. For example, the cache eviction policy of the first level cache 130 causes the data to be written to the second level cache 132 in accordance with a determination that a page, block, or other write unit of the first level cache 130 has been filled, in accordance with a determination that the data associated with a write command has completed being written to SRAM 114, in accordance with a determination that a size of the write buffer 124 has reached or exceeded a predefined threshold (e.g., maximum size), and/or in accordance with a determination that a time threshold has been satisfied (e.g., the time threshold has elapsed since a previous cache eviction).

In an example illustrated in FIG. 2, in response to a write data command 202 received from the host 102, the controller 104, using read/write control logic 106, writes (204) the data to the first level cache 130 that is resident in SRAM 114. In some cases, writing the data to the first level cache 130 requires (e.g., causes, in accordance with a cache eviction policy of the first level cache) the eviction (206) of some data from the first level cache 130, to make room for the storage of other data in the first level cache 130. In addition, the controller 104 updates (207) the SRAM/NVM1 mapping tables 108, which are stored in SRAM 114, to indicate what data is now (e.g., currently) stored in the first level cache 130. For example the data stored in the first level cache 130 may be identified in the SRAM/NVM1 mapping tables 108 by the host addresses of that data, which are addresses in the address space used by the host 102.

Continuing the example shown in FIG. 2, when data is evicted (206) from the write buffer 124 of the first level cache 130 and written (208) to the second level cache 132 (e.g., to the write buffer 118 of the second level cache 132), the controller 104 updates (207) the SRAM/NVM1 mapping tables 108, which are stored in SRAM 114, to indicate what data is now (e.g., currently) stored in the second level cache 132.

In some cases, writing data (208) to the second level cache 132 requires (e.g., causes, in accordance with a cache eviction policy of the second level cache) the eviction (210) of some data from the second level cache 132, to make room for the storage of other data in the second level cache 132. In addition, the controller 104 updates (207) the SRAM/NVM1 mapping tables 108, of which the NVM1 mapping table is stored in NVM1, with a subset stored in SRAM 114, to indicate what data is now (e.g., currently) stored in the second level cache 132. The data stored in the second level cache 132 may be identified in the SRAM/NVM1 mapping tables 108 by the host addresses of that data, which are addresses in the address space used by the host 102.

Continuing the example shown in FIG. 2, data is evicted (210) from the write buffer 118 of the second level cache 132 and written (212) to main memory 101 of the second NVM 120 in accordance with a cache eviction policy for the second level cache 132. In some embodiments, the cache eviction policy for the second level cache 132 is different from the cache eviction policy for the first level cache 130. When data is evicted (210) from the write buffer 118 of the second level cache 132 and written (212) to the main memory 101, the controller 104 updates (211) the SRAM/NVM1 mapping tables 108 and NVM2 mapping table(s), to indicate what data is now (e.g., currently) stored in the second level cache 132 and what data is now (currently) stored in main memory 101.

From another perspective, a respective write operation, such as operation 204, 208 or 212, includes updating one or more of the mapping tables, so as to record the location(s) at which the newly written data can be accessed (e.g., locations in memory subsystem 100 from which the data can be retrieved). More generally, in some embodiments, each cache eviction and corresponding write operation, such as 206/208 or 210/212, includes updating one or more mapping tables to indicate that the evicted data is no longer stored at the memory locations at which it was previously stored and to indicate the new memory locations at which the data is stored. If, as a result of the write operation, data is stored in more than one location in the NVMM subsystem 100, the mapping tables are updated to include information indicating the memory location where each copy of such data is stored.

In some embodiments, the read cache 116 in the first NVM 103 stores the active portion of one or more files. In some embodiments, if the file is still stored in the read cache 116, the file is retrieved from the first NVM 103 in response to a read data command received from the host 102. For example, as illustrated in FIG. 2, in response to a read data command 214 received from the host 102, the controller 104 (e.g., using read/write control logic 106) retrieves or accesses mapping tables (216) (e.g., SRAM/NVM1 mapping tables 108 and/or NVM2 mapping table(s) 110) to identify the locations at which the requested data, corresponding to the read data command, is stored. If the identified locations are located in SRAM 114, the controller 104 reads the requested data from its stored location(s), including reading data (218) that is stored in SRAM 114 (e.g., from the read cache/write buffer overlap region 125, in cases where the data has not yet been written to the second level cache 132 in the first NVM 103, or not yet evicted from the first level cache 130 in SRAM 114) and/or read cache 122, and the read data is returned to the host 102 in response to the read data command 214.

If the identified locations are located in the first NVM 103, the controller 104 reads (222) the requested data from the write buffer 118 and/or read cache 116 in the second level cache 132 in the first NVM 103 (e.g., in cases where the data has not yet been written to the second NVM 120, or not yet evicted from the second level cache 132 in the first NVM 103), and writes (223) the requested data to the first level cache 130 (e.g., to the read cache 122), and then the requested data is read (218) from the first level cache 130 and returned to the host 102 in response to the read data command 214. In addition, the mapping tables are updated (223) to reflect that the requested data is now stored in the first level cache 130. However, in some embodiments, if the data read command 214 is a block read command (e.g., a data read command that requests all the data stored in an entire memory block in the first NVM 103), the controller 104, instead of writing data to the first level cache 130, directly delivers the requested data from the first NVM 103 to the host 102 via data path 144 (see FIG. 1).

If the identified locations (corresponding to read command 214) are located in the second NVM 120 (e.g., in the main memory 101), the controller reads (224) the requested data from the second NVM 120 and writes (225) that data to the first level cache 130 (e.g., to the read cache/write buffer overlap portion 125 in SRAM 114). In addition, the mapping tables 108, 110 are updated (225) to reflect that the requested data is now stored in the first level cache 130. The requested data is written from main memory 101 to the first level cache 130 so that it is available to satisfy the host read command. In some embodiments, once the requested data has been written to the first level cache 103, the aforementioned read operation 218 is performed in response to the read data command 224. Concurrently, or shortly thereafter, such data is written to the read cache 116 in the second level cache 132 under the control of control logic 142, and the mapping tables are updated (227) to reflect that the requested data is now stored in the both the first level cache 130 and second level cache 132, as well as main memory 101. In some embodiments, if data is read from main memory 101 as part of a prefetch operation (e.g., a prefetch operation performed by a memory controller (e.g., which may be part of the host system 102) when the host 102 has started reading a file, and the memory controller anticipates that additional portions of the same file will be requested by the host 102 in the near future), prior to being requested by a read data command from the host 102, data read from main memory 101 is written directly to the write buffer 124 in the first level cache 130, and from there is written to the read cache 116 in the second level cache 132.

As can be seen from the above discussion, the first level cache 130 serves multiple purposes, including the initial storage of data written by the host 102 to the NVMM subsystem 100, caching data that is being read by the host 102, buffering data to be written to the second level cache, and storing data that has been read from either main memory 101 or the second level cache 132 in response to a read data command received from the host 102. Similarly, the second level cache 132 serves multiple purposes, including caching data written by the host 102 to the NVMM subsystem 100 so as to make it available for reading by the host 102 at much faster speed and with lower latency than reading data from main memory 101 in the second NVM 120, storing (caching) data that has been read by the host 102 from main memory 101 (e.g., after such data has been stored in the first level cache, and then copied to the second level cache), and buffering data to be written to main memory 101. Furthermore, the controller 104 includes read/write logic 106 for managing the movement of data between the various portions of NVMM subsystem 100, and includes mapping tables logic 109 and 111 for maintaining and updating SRAM/NVM1 mapping tables 108 and NVM2 mapping tables 110 to keep track of where data, and copies of data, are stored in the NVMM subsystem 100 to maintain coherence of the NVMM subsystem 100.

In some embodiments, the NVMM subsystem 100 concurrently reads and writes data (e.g., a write command and a read command are executed during overlapping time periods).

### Non-Volatile Memory Sizes

In some embodiments, the first type of non-volatile memory (e.g., NOVRAM), in the first NVM 103, has a first write endurance (e.g., average write endurance, wherein the average write endurance reflects the number of program/erase (PE) cycles a unit of memory, or the memory as whole, can withstand on average before becoming unreliable) and the second type of non-volatile memory (e.g., NAND memory), in NVM 120, has a second write endurance (average write endurance), where the first write endurance of the first type of non-volatile memory is greater than the second write endurance of the second type of non-volatile memory (e.g., at least 10 times, or at least 100 times the second write endurance, and, preferably, at least one thousand times the second write endurance). For example, in some embodiments, the write endurance of the first type of non-volatile memory (e.g., NOVRAM) in the first NVM 103 is at least one million, 10⁷, 10⁸, or 10⁹ P/E cycles, and the write endurance of the second type of non-volatile memory (e.g., NAND memory) in the second NVM 120, is at least one thousand P/E cycles.

In some embodiments, the second NVM 120 has a second storage capacity, excluding overprovisioning and metadata storage, that is at least ten times (e.g., at least 10 times, 100 times, 1000 times, or another amount) as large as a first storage capacity, excluding overprovisioning and metadata storage, of the first NVM 103. In some embodiments, the minimum size of the write buffer 118 in the first NVM 103 (NVM1) is based at least in part on the write endurance of NVM1 103 and the write endurance and storage capacity, excluding overprovisioning and metadata storage, of the second NVM 120 (NVM2).

In some embodiments, a minimum size of the write buffer 118 in the second level cache 132 (NVM1 write buffer 118) is defined by:

$$write endurance of NVM 1 \times NVM 1 write buffer size \geq write endurance of NMV 2 \times NVM 2 size , \\ or \\ \frac{NVM 1 write buffer size}{NVM 2 size} \geq \frac{write endurance of NVM 2}{write endurance of NVM 1} .$$

In one example, for a non-volatile memory subsystem 100 with a specified NVM2 write endurance (sometimes called the NVMM subsystem lifetime write endurance) of 1000 P/E cycles, a main memory 101 (in second NVM 120) memory size of 200 GB (excluding overprovisioning and metadata storage), and a first NVM 103 write endurance of at least 107 P/E cycles, the minimum size of the write buffer 118 in the first NVM 103 is 20 MB (i.e., 1/10,000 of the main memory size) (where all the aforementioned memory sizes/capacity sizes exclude overprovisioning and metadata storage). In another example, for a non-volatile memory subsystem 100 with an NVM2 write endurance of at least one thousand P/E cycles, NVM1 103 write endurance of at least 107 P/E cycles, and a main memory 101 (in second NVM 120) memory size of 2 TB, the minimum size of the NMV1 write buffer 118 (excluding over provisioning and metadata storage) would be 200 MB (e.g., 2 TB/10⁴). However, for a 2 TB main memory 101, the NVM2 mapping tables 110 (which are stored in NVM1 103) may be as large as 2 GB, and therefore the NMV1 103 would need to be at least 10 GB in size, with the remaining 8 GB capacity primarily reserved for the read cache 116 and a small portion for the NVM1 mapping table 108. In general, allocating higher capacity to the read cache 122 of the first level cache 130 and the read cache 116 of the second level cache 132 improves system performance (of the NVMM subsystem 100). The trade off is cost, as the per unit cost (e.g., cost per megabyte) of SRAM and NOVRAM is substantially higher than that of NAND memory.

Because the first NVM 103 (second level cache 132) is non-volatile, data in the first NVM 103 (second level cache 132) will not be lost in the event of a power outage or interruption. As a result, the only data that needs backup in the event of a power failure or interruption are the changed portions of the subset of mapping tables stored in SRAM 114, any other metadata in SRAM 114 not already saved to the first NVM 103, and data stored in the write buffer 124, which are relatively small in capacity, and the backup of the aforementioned data (e.g., changed portions of the mapping tables, other metadata, and the write buffer) can be accomplished with the energy supplied by a relatively small power source, such as a capacitor that is internal (e.g., power source 140) to, or external to the NVMM subsystem 100.

In some embodiments, the main memory subsystem includes an internal power source 140 (or alternatively is coupled to an external power source) sufficient to write the aforementioned data in the SRAM 114 to the first NVM 103 in the event of a power failure or interruption. In some embodiments, the NVMM subsystem 100 includes logic 142 (e.g., as part of the controller 104) for writing data from the first level cache 130 in the SRAM 114 to the second level cache 132 and for saving information from the mapping tables in the SRAM to the first NVM 103 in the event of a power failure or interruption.

In some embodiments, the first NVM 103 (e.g., the first type of non-volatile memory, such as NOVRAM, used to implement the first NVM 103) has a first erase unit size (sometimes called a first erase sector size) and the second NVM 120 (e.g., the second type of non-volatile memory used to implement the second NVM 120) has a second erase unit size (sometimes called a second erase sector size) that is at least one hundred times as large (or, in some embodiments, at least 128 times, 256 times, or even higher numbers of times as large) as the first erase unit size. In some embodiments, the erase unit size of the second NVM 120 (e.g., NAND memory) is an entire block unit (e.g., 1 MB to 32 MB), while the erase unit size for the first NVM 103 (e.g., NOVRAM) is a 4 KB block.

In some embodiments, the first NVM 103 (e.g., NOVRAM) has a first write unit size and the second NVM 120 (e.g., NAND memory) has a second write unit size that is at least ten times (or, in some embodiments, at least 64 or 128 times) as large as the first write unit size. For example, the second NVM 120 comprises NAND flash memory that writes a 4 KB or 128 KB block with each write operation, each block having a predefined number of pages, while the write unit in the first NVM 103, comprising NOVRAM, is more granular than NVM 120, with a write unit of 8 bytes to 4K bytes. In some embodiments, the write unit and erase unit in the first NVM 103 are the same size (e.g. both are 4 KB in size) to eliminate the need for garbage collection before an erase operation (e.g., when data is invalidated in the first NVM 103, all data in each erase block that is affected by the invalidation is marked as invalid, and thus no valid data remains in those erase blocks, thereby eliminating the need for garbage collection).

In some embodiments, the first NVM 103 has a first read speed (e.g., a first read rate (e.g., amount of data per unit of time) at which data is read from the first NVM 103 and a first write speed (e.g., a first write rate (e.g., amount of data per unit of time) at which data is written to the first NVM 103, and the second NVM 120 has a second read speed that is (e.g., at least 10, 100 or 1000 times) slower than the first read speed and a second write speed that is (e.g., at least 10, 100 or 1000 times) slower than the first write speed.

In some embodiments, mapping tables are stored (e.g., in SRAM 114) to map (e.g., keep track of) the locations of the data written to the NVMM subsystem 100 (e.g., to the first level cache 130 in SRAM 114, the second level cache 132 in the first NVM 103, and main memory 101 in the second NVM 120). For example, a first set of mapping table stores the logical address for (e.g., corresponding to) each location in the first NVM 103 (and optionally SRAM 114, and further optionally the second NVM 120) in which data (e.g., valid data) and metadata are stored, and a second set of mapping tables that identifies locations in (stores location pointers identifying locations in) the second NVM 120 in which data (e.g., valid data) and metadata are stored. In some embodiments, for a 2 TB main memory, a size of the first set of mapping tables is approximately 10 MB of SRAM and a size of the second set of mapping tables is approximately 2 GB. For example, the controller 104 is configured to maintain a first set of address mapping tables (e.g., SRAM/NVM1 mapping tables 108) and a second set of address mapping tables (e.g., NVM2 mapping table(s) 110), wherein the first set of address mapping tables is stored in the SRAM 114, with a backup copy in the first NVM 103, and includes entries that map addresses in an address space of the host system (e.g., host 102) to locations in the SRAM 114, first NVM 103, or second NVM 120, and the second set of address mapping tables is stored in the first NVM 103 and includes entries storing pointers to locations in the second NVM 120 that store host data and metadata. More generally, a variety of different multilevel address mapping tables may be used by the controller 104 to keep track of the locations at which data is stored in the SRAM, first non-volatile memory, and second non-volatile memory.

The foregoing description has been described with reference to specific implementations. However, the illustrative discussions above are not intended to be exhaustive or to limit the claims to the precise forms disclosed. Many variations are possible in view of the above teachings. The implementations were chosen and described to best explain principles of operation and practical applications, to thereby enable others skilled in the art.

The various drawings illustrate a number of elements in a particular order. However, elements that are not order dependent may be reordered and other elements may be combined or separated. While some reordering or other groupings are specifically mentioned, others will be obvious to those of ordinary skill in the art, so the ordering and groupings presented herein are not an exhaustive list of alternatives.

What is claimed is:

1. A main memory subsystem, comprising:
a main memory interface for communicating with a host system;
static random-access memory (SRAM);
first non-volatile memory, comprising a first type of non-volatile memory, the first non-volatile memory having first storage capacity, excluding overprovisioning and metadata storage, first write endurance, first erase speed, and first programming speed; and
second non-volatile memory, comprising a second type of non-volatile memory different from the first type of non-volatile memory; the second non-volatile memory having second storage capacity, excluding overprovisioning and metadata storage, of at least ten times as large as the first storage capacity, excluding overprovisioning and metadata storage, of the first non-volatile memory; the first type of non-volatile memory having write endurance that is at least ten times write endurance of the second type of non-volatile memory, erase speed that is at least twice as fast as erase speed of the second type of non-volatile memory, and/or programming speed that is at least ten times as fast as programming speed of the second type of non-volatile memory;
main memory, resident in the second non-volatile memory, for storing data;
a first level cache resident in the SRAM, from which the host system accesses data stored in the main memory system;
a second level cache, resident in the first non-volatile memory, having greater storage capacity than the first level cache; and
a controller for maintaining one or more address mapping tables that map host-specified memory locations to locations in the first level cache, second level cache and/or main memory.

2. The main memory subsystem of claim, wherein the controller includes read/write logic for caching in the second level cache data read from the main memory, for storing in a write buffer of the second level cache host data written to the main memory subsystem by the host system, and for updating one or more of the address mapping tables, upon writing such host data from the write buffer of the second level cache to the main memory, to map host-specified memory locations for such host data to a read cache of the second level cache.

3. The main memory subsystem of claim, wherein the controller includes read/write logic for caching in the first level cache data read from the main memory, and for copying from the first level cache to the second level cache a copy of such data read from main memory.

4. The main memory subsystem of claim 1, wherein the first type of non-volatile memory has write endurance that is at least one hundred times the write endurance of the second type of non-volatile memory, and/or programming speed that is at least one hundred times as fast as the programming speed of the second type of non-volatile memory.

5. The main memory subsystem of claim 1, wherein the controller includes logic for maintaining coherence of the main memory subsystem by updating a set of address mapping tables that map host-specified memory locations to locations in the first level cache, the second level cache and main memory.

6. The main memory subsystem of claim 1, wherein the controller includes logic for monitoring and maintaining the health of memory blocks in the first non-volatile memory and the second non-volatile memory.

7. The main memory subsystem of claim 1, wherein the first level cache includes a first write buffer for buffering data to be written to the second level cache and a first read cache, and the controller includes read/write control logic for initially storing data received from the host system to a portion of the first level cache that belongs to both the first write buffer and the first read cache of the first level cache.

8. The main memory subsystem of claim, wherein the read/write control logic stores data received from the host system to the portion of the first level cache that belongs to both the first write buffer and the first read cache until said data is written to the second level cache.

9. The main memory subsystem of claim 1, wherein the second level cache includes a read cache for storing a copy of data read from the main memory, and a write buffer for buffering data to be written to main memory.

10. The main memory subsystem of claim 1, wherein the controller is configured to write data from the first level cache to the second level cache in accordance with a cache eviction policy for the first level cache.

11. The main memory subsystem of claim 1, wherein the controller is configured to write data from the second level cache to the main memory in accordance with a cache eviction policy for the second level cache.

12. The main memory subsystem of claim 1, including an internal power source sufficient to write data from the first level cache in the SRAM to the second level cache in the event of a power failure.

13. The main memory subsystem of claim 1, including an internal power source sufficient to write buffered data from the first level cache in the SRAM to the second level cache and to save information from one or more address mapping tables in the SRAM to the first non-volatile memory in the event of a power failure.

14. The main memory subsystem of claim, including logic for writing buffered data from the first level cache in the SRAM to the second level cache and for saving information from the one or more address mapping tables in the SRAM to the first non-volatile memory in the event of a power failure.

15. A main memory subsystem, comprising:
a main memory interface for communicating with a host system;
static random-access memory (SRAM);
first non-volatile memory having a first write endurance;
second non-volatile memory having a second write endurance, wherein the first write endurance of the first non-volatile memory is greater than the second write endurance of the second non-volatile memory; and
a controller for successively writing data to the SRAM, the first non-volatile memory, and then the second non-volatile memory in response to a write command received from the host system.

16. The main memory subsystem of claim, wherein the first write endurance of the first non-volatile memory is at least one hundred times greater than the second write endurance of the second non-volatile memory.

17. The main memory subsystem of claim 15, wherein the controller is further configured to store a first set of address mapping tables and a second set of address mapping tables, wherein the first set of address mapping tables is stored in the SRAM and includes entries that map addresses in an address space of the host system to locations in the SRAM, first non-volatile memory or second non-volatile memory, and the second set of mapping tables is stored in the first non-volatile memory and includes entries storing pointers to locations in the second non-volatile memory that store data.

18. The main memory subsystem of claim 15, wherein the second non-volatile memory has a second storage capacity, excluding overprovisioning and metadata storage, that is at least ten times as large as a first storage capacity, excluding overprovisioning and metadata storage, of the first non-volatile memory.

19. The main memory subsystem of claim 15, wherein the first non-volatile memory has a first erase unit size and the second non-volatile memory has a second erase unit size that is at least one hundred times as large as the first erase unit size.

20. The main memory subsystem of claim 15, wherein the first non-volatile memory has a first write unit size and the second non-volatile memory has a second write unit size that is at least ten times as large as the first write unit size.

21. The main memory subsystem of claim 15, wherein the first non-volatile memory has a first read speed and a first write speed and the second non-volatile memory has a second read speed that is slower than the first read speed and a second write speed that is slower than the first write speed.

22. The main memory subsystem of claim 15, wherein the first non-volatile memory includes a write buffer that is used by the controller to buffer data to be written to the second non-volatile memory.

23. The main memory subsystem of claim, wherein the first non-volatile memory includes an information cache that is used by the controller when reading data from the second non-volatile memory in response to an instruction initiated by the host system.

24. The main memory subsystem of claim 15, including:
a first level cache resident in the SRAM, from which the host system accesses data stored in the main memory system; and
a second level cache, resident in the first non-volatile memory, having greater storage capacity than the first level cache, wherein the second level cache is for storing a copy of data read from the second non-volatile memory and data to be written to the second non-volatile memory;
wherein the controller is configured to update one or more address mapping tables that map host-specified memory locations to locations in the first level cache, the second level cache and the second non-volatile memory, so as to maintain coherence of the main memory subsystem.

25. The main memory subsystem of claim 15, wherein the main memory interface comprises a DRAM-compatible interface.

26. The main memory subsystem of claim 15, wherein the controller is configured to retrieve data from one of the SRAM, first non-volatile memory or second non-volatile memory, in response to a read command received from the host, and transmit the retrieved data to the host.

27. The main memory subsystem of claim 15, wherein the first non-volatile memory comprises a type of non-volatile memory having write endurance of at least one million program/erase cycles.

28. The main memory subsystem of claim 15, wherein the second non-volatile memory has a storage capacity that is at least 20 times the storage capacity of the first non-volatile memory.

29. The main memory subsystem of claim 15, wherein the main memory subsystem does not include DRAM that stores the host data written by the host system to the main memory subsystem.

30. The main memory subsystem of claim 15, wherein the first non-volatile memory comprises NOVRAM or high speed NOR flash memory, and the second non-volatile memory comprises NAND flash memory.
